(19) United States
(12) Patent Application Publication
(10) Pub. No.: US 2024/0166825 A1
(43) Pub. Date: May 23, 2024

(54) Method For Wetting And Dispersion Of Acrylic Acid Polymers

(71) Applicant: Lubrizol Advanced Materials, Inc., Cleveland, OH (US)

(72) Inventors: Sinan Li, Hudson, OH (US); David W. Weaver, Columbia Station, OH (US); Di Shen, Beijing (CN); Ge Yao; Jingjuan Qi, Shanghai (CN); Samuel T. Williams, Barberton, OH (US); Michael Knopf, Hackettstown, NJ (US)

(73) Assignee: Lubrizol Advanced Materials, Inc., Cleveland, OH (US)

(21) Appl. No.: 18/548,603

(22) PCT Filed: Mar. 4, 2022
(86) PCT No.: PCT/US2022/018880

§ 371 Date: Sep. 1, 2023

Related U.S. Application Data
(60) Provisional application No. 63/156,965, filed on Mar. 5, 2021.

(51) Int. Cl. C08J 3/05

(52) U.S. Cl. CPC C08J 3/05; C08J 2333/10

(57) ABSTRACT

The disclosed technology concerns a method for wetting and dispersing a pulverulent polycarboxylic acid containing polymer in aqueous media without the need of a steric stabilizer and/or a wetting agent, said method comprises a) providing a pulverulent pre-neutralized carboxylic acid containing polymer or copolymer, wherein said polymer or copolymer is prepared from a monomer mixture comprising at least one olefinically unsaturated carboxylic acid group containing monomer, and wherein from about 1 to about 10 wt. % of said carboxylic acid group containing monomer(s) is neutralized; b) mixing said pulverulent pre-neutralized carboxylic acid containing polymer or copolymer in aqueous medium; and c) mixing a deswelling agent selected from an acid, a salt, and combinations thereof with said aqueous medium, and optionally d), adjusting the pH.

### TECHNOLOGICAL FIELD

The present technology relates to carboxylic acid polymers which are used as thickeners, emulsifiers and suspending aids having improved wettability and dispersibility in liquid systems comprising an aqueous phase. In particular, the technology relates to a method to efficiently disperse crosslinked homopolymers and copolymers of partially neutralized olefinically unsaturated carboxylic acids in aqueous media in the presence of a deswelling agent. The crosslinked homopolymers and copolymers prepared from partially neutralized olefinically unsaturated carboxylic acids do not require the presence of a steric stabilizer and/or a wetting agent to achieve improved wettability and dispersibility characteristics in aqueous media.

### BACKGROUND

Polymers prepared from olefinically unsaturated carboxylic acids are well-known. Such polymers may be homopolymers of unsaturated polymerizable carboxylic acids, such as acrylic acid, methacrylic acid, maleic acid, maleic anhydride, itaconic acid and the like; or copolymers of these acids or anhydrides with (meth)acrylate esters. Homopolymers and copolymers of these acids may be cross-linked with small amounts of crosslinking agents. These polymers are normally prepared by polymerization with a free radical catalyst in an organic medium in a closed vessel or autoclave equipped with stirring. During polymerization, the polymer precipitates from the solution as it is formed. The precipitated polymer is recovered and dried to remove residual solvent. The polymer, now in a powder form, is used by dispersing it in water and neutralizing it to activate its thickening, suspending or emulsifying ability. Such polymers are disclosed in U.S. Pat. Nos. 2,798,053; 3,915,921; 3,940,351; 4,062,817; 4,066,583; and 4,267,103.

Polycarboxylic acid polymers in powder form historically have proven difficult to disperse in aqueous media, such as water. Special and often burdensome measures are typically required. Due to their very strong hydrophilic nature, particles of such polymers immediately begin swelling upon contact with water. When a large number of powder particles are added as a group to water, during swelling, a skin of hydrated particles can form around other dry particles before those dry particles can themselves be hydrated. The result is lumps of undispersed particles which cannot be easily eliminated. This phenomenon is evident even when a small quantity (one gram or less) of crosslinked polyacrylic acid powder is dropped into water that is being agitated. During the formulation of compositions with crosslinked polyacrylic acid powder, the polymer particles that are not fully hydrated are difficult to remove resulting in lumpy gels dispersed within the end product.

U.S. Pat. No. 5,288,814 describes interpolymers of acrylic acid and optional comonomers which are polymerized in the presence of a steric stabilizer surfactant comprising at least one hydrophilic moiety and at least one hydrophobic moiety arranged in a linear block copolymer configuration or a random comb copolymer configuration. Both steric stabilizer polymer configurations contain hydrophilic moieties comprising polyoxyethylene ether groups. The solid acrylic based polymers obtained from the disclosed polymerization procedure are characterized by their ease of handling and the ability to be easily dispersed in aqueous media. The interpolymer is said to be less hydrophilic, and so the individual powder particles swell slowly, avoiding the rapid creation of a skin that would otherwise prevent hydration of all powder particles. When the steric-stabilized polyacrylic acid interpolymer powder is added to water, one observes the absorption of water into the powder. As the particles wet, they form soft clusters of hydrated particles which eventually sink below the surface of the water. Once the particles are wetted out, they will begin to disperse throughout the water. Upon neutralization with an organic or inorganic base, the hydrated particles and clusters of hydrated particles greatly expand, eventually resulting in a smooth gel or viscous liquid.

U.S. Pat. No. 5,373,044 discloses interpolymers of acrylic acid and optional comonomers which are polymerized in the presence of the steric stabilizer described in U.S. Pat. No. 5,288,814 and a wetting agent. The wetting agent selected from a low surface tension surfactant, glycols, polyhydric alcohols, and mixtures thereof. The interpolymer is said to have improved wettability characteristics while retaining excellent thickening efficiency.

U.S. Pat. No. 9,725,589 describes a process for preparing polymers of acrylic acid and optional comonomers by the free-radical polymerization of a monomer composition comprising: a) at least one ethylenically unsaturated carboxylic acid containing monomer or anhydride thereof; b) optionally at least one ethylenically unsaturated monomer different from a) but copolymerizable therewith; and c) at least one crosslinking monomer containing at least two ethylenically unsaturated groups. The monomer composition is polymerized in an organic medium having a solubilizing effect on one or more of the monomeric ingredients, but substantially none on the resulting polymer. The polymerization is conducted in the presence of at least one steric stabilizing polymer prepared from a vinyl lactam and a copolymerizable monomer selected from a short chain alkyl ester of (meth)acrylic acid, a long chain alkyl ester of (meth)acrylic acid, and combinations thereof. Aqueous mucilages formulated from the polymer product are characterized by good clarity, good texture, and improved polymer dissolution properties.

While the prior art has attempted to solve several of the inherent problems associated with the wetting and dispersing of powdered carboxylic acid based polymers in aqueous media, there is still a need for an efficient wetting and dispersion process for producing thickened aqueous media compositions without the need for polyacrylic acid interpolymers prepared with steric stabilizers and/or wetting aids.

### SUMMARY OF THE DISCLOSED TECHNOLOGY

A general aspect of the present technology relates to a method for wetting and dispersing a pulverulent polycarboxylic acid containing polymer in aqueous media comprising:
a) providing a pulverulent pre-neutralized carboxylic acid containing polymer or copolymer, wherein said polymer or copolymer is prepared from a monomer mixture comprising at least one olefinically unsaturated carboxylic acid group containing monomer, and wherein from about 1 to about 15 wt. % of said carboxylic acid group containing monomer(s) is neutralized;
b) mixing said pulverulent pre-neutralized carboxylic acid containing polymer or copolymer in aqueous medium; and
c) mixing a deswelling agent selected from an acid, a salt, and combinations thereof with said aqueous medium.

In another aspect, the present technology relates to a method for thickening a composition comprising an aqueous phase comprising:
a) providing a pulverulent partially-neutralized carboxylic acid containing polymer or copolymer, wherein said polymer or copolymer is prepared from a monomer mixture comprising at least one olefinically unsaturated carboxylic acid group containing monomer, and wherein from about 1 to about 15 wt. % of said carboxylic acid group containing monomer(s) is neutralized;
b) mixing said pulverulent pre-neutralized carboxylic acid containing polymer or copolymer in an aqueous phase;
c) mixing a deswelling agent selected from an acid, a salt, and combinations thereof in said aqueous phase; and
d) optionally adjusting the pH of the aqueous phase to a desired value between from about 4.5 to about 10.

Surprisingly and unexpectedly, it has now been observed, that it is possible to formulate pulverulent polycarboxylic acid containing polymers into aqueous media without the need for steric stabilizers and/or wetting agents traditionally employed by the prior art.

### DETAILED DESCRIPTION OF THE DISCLOSED TECHNOLOGY

In all aspects of the disclosed technology, all percentages are calculated by the weight of the total composition. All ratios are expressed as weight ratios. All numerical ranges of amounts are inclusive and combinable unless otherwise specified.

While overlapping weight ranges for the various components and ingredients that can be contained in the disclosed compositions have been expressed for selected embodiments and aspects of the disclosed technology, the amount of each component in the disclosed compositions is selected from its disclosed range such that the sum of all components or ingredients in the composition will total 100 weight percent. The amounts employed will vary with the purpose and character of the desired product and can be readily determined by one skilled in the art.

The prefix “(meth)acryl” includes “acryl” as well as “methacryl”. For example, the term “(meth)acrylic acid” includes both acrylic acid and methacrylic acid.

The terms “wet out”, “wetting out”, and “wetted out” are used interchangeably and refer to pulverulent polymer particles that are fully hydrated and are devoid of dry regions called “fisheyes” within the particle. Hydrated particles sink below the surface of the water and spontaneously to disperse throughout a water medium. When fully hydrated, the polymer particles change from white to translucent.

The term “personal care” as used herein includes, without being limited thereto, includes cosmetics, toiletries, cosmeceuticals, beauty aids, insect repellents, sun screens, UV absorbers, creams, lotions, personal hygiene and cleansing products (e.g., shampoos, conditioning shampoos, anti-dandruff shampoos, rinse-off conditioners, body-washes, shower creams, shower lotions, shower gels, exfoliating compositions, liquid hand soaps and washes, facial scrubs, facial washes, astringent lotions, skin toners or fresheners, bubble baths, soluble bath oils, and the like) applied to the body, including the skin, hair, scalp, and nails of humans and animals.

The pulverulent carboxylic acid containing polymers of the present technology are prepared from a monomer mixture comprising at least one olefinically unsaturated carboxylic acid group containing monomer. Such polymers are homopolymers of olefinically unsaturated, polymerizable carboxylic monomers such as acrylic acid, methacrylic acid, 2-carboxyethyl acrylate, maleic acid, itaconic acid, maleic anhydride, and mixtures thereof, and copolymers of polymerizable carboxylic monomers with alkyl esters of (meth)acrylic acid.

In one aspect, the monomer mixture comprises at least one olefinically unsaturated carboxylic acid group containing monomer is selected from (meth)acrylic acid and/or carboxyethyl acrylate represented by the formula:

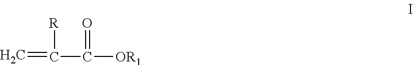

wherein R is H or methyl, and R₁ is H or —(CH₂)₂COOH.

In one aspect, from about 1 to about 10 wt. %, or from about 2 to about 8 wt. %, or from about 3 to about 7 wt. %, or from about 4 to about 6 wt. % of the at least one olefinically unsaturated carboxylic acid group containing monomer in the monomer mixture is pre-neutralized with a neutralization agent prior to polymerization. Suitable neutralization agents include group 1A metal (e.g., lithium, sodium, potassium, cesium) hydroxides, oxides, and carbonates; ammonium hydroxides, oxides, and carbonates; and ammonia and other amines including morpholine, monoethanolamine, diethanolamine, triethanolamine, and monopropanolamine.

The at least one olefinically unsaturated carboxylic acid group containing monomer can be neutralized before addition to the polymerization reactor or can be neutralized in situ in the reactor prior to initiating the polymerization reaction.

The polymers include both homopolymers of partially neutralized carboxylic acids or anhydrides thereof, or the defined partially neutralized carboxylic acids copolymerized with at least one C₁-C₃₀ alkyl ester of (meth)acrylic acid of the formula:

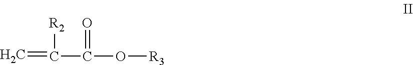

wherein R₂ is selected from hydrogen, methyl and ethyl; R₃ is an alkyl group containing 1 to 30 carbon atoms, or 10 to 30 carbon atoms, or 2 to 20 carbon atoms, or 2 to 18 carbon atoms.

Such monomers include, for example, at least one acrylic acid ester monomer selected from methyl (meth)acrylate, ethyl (meth)acrylate, propyl (meth)acrylate, isopropyl (meth)acrylate, butyl (meth)acrylate, isobutyl (meth)acrylate, methyl ethacrylate, hexyl (meth)acrylate, n-hexyl (meth)acrylate, heptyl (meth)acrylate, octyl (meth)acrylate, 2-ethylhexyl (meth)acrylate, nonyl (meth)acrylate, decyl (meth)acrylate, isodecyl (meth)acrylate, lauryl (meth)acrylate, myristyl (meth)acrylate, stearyl (meth)acrylate, behenyl (meth)acrylate and melissyl (meth)acrylate.

The polymers also may be cross-linked with at least one polyunsaturated crosslinking monomer. Exemplary polyunsaturated crosslinking monomer components include di(meth)acrylate compounds such as ethylene glycol di(meth)acrylate, polyethylene glycol di(meth)acrylate, triethylene glycol di(meth)acrylate, 1,3-butylene glycol di(meth)acrylate, 1,6-butylene glycol di(meth)acrylate, 1,6-hexanediol di(meth)acrylate, neopentyl glycol di(meth)acrylate, 1,9-nonanediol di(meth)acrylate, 2,2′-bis(4-(acryloxy-propyloxyphenyl)propane, and 2,2′-bis(4-(acryloxydiethoxy-phenyl)propane; tri(meth)acrylate compounds such as, trimethylolpropane tri(meth)acrylate, trimethylolethane tri(meth)acrylate, and tetramethylolmethane tri(meth)acrylate; tetra(meth)acrylate compounds such as ditrimethylolpropane tetra(meth)acrylate, tetramethylolmethane tetra(meth)acrylate, and pentaerythritol tetra(meth)acrylate; hexa(meth)acrylate compounds such as dipentaerythritol hexa(meth)acrylate; allyl compounds such as allyl (meth)acrylate, diallylphthalate, diallyl itaconate, diallyl fumarate, and diallyl maleate; polyallyl ethers of sucrose having from 2 to 8 allyl groups per molecule, polyallyl ethers of pentaerythritol such as pentaerythritol diallyl ether, pentaerythritol triallyl ether, and pentaerythritol tetraallyl ether, and combinations thereof; polyallyl ethers of trimethylolpropane such as trimethylolpropane diallyl ether, trimethylolpropane triallyl ether, and combinations thereof. Other suitable polyunsaturated compounds include divinyl glycol, divinyl benzene, and methylenebisacrylamide. In one aspect, allyl pentaerythritol, trimethylolpropane diallyl ether, allyl sucrose, allyl methacrylate, and methylenebisacrylamide provide excellent polymers. When the polyunsaturated crosslinking monomer is present, the monomer mixture usually contains up to about 5 wt. % of crosslinking monomer based on the total of monomers in the monomer mixture. In one aspect, the amount of polyunsaturated crosslinking monomer can range from about 0.01 to 3.0 wt. %, or from about 0.05 to about 2.5 wt. %, or from about 0.1 to about 1 wt. %, or from about 0.3 to about 0.75 wt. %, based on the total weight of the monomers in the monomer mixture.

When homopolymers prepared from the partially neutralized olefinically unsaturated carboxylic acid containing monomer or anhydride are contemplated, the amount of carboxylic group containing monomer present in the polymerizable monomer mixture ranges from about 95 to about 99.99 wt. %, and the amount of optional polyunsaturated crosslinking monomer ranges from about 0.01 to about 5 wt. % based on the total weight of monomers in the polymerizable monomer mixture. In another aspect, the amount of polyunsaturated crosslinking monomer in the polymerizable monomer mixture can range from about 0.01 to 3.0 wt. %, or from about 0.05 to about 2.5 wt. %, or from about 0.1 to about 1 wt. %, or from about 0.3 to about 0.75 wt. % with the balance made up by the partially neutralized olefinically unsaturated carboxylic acid containing monomer to total 100 wt. % of the monomer mixture.

When copolymers prepared from the partially neutralized olefinically unsaturated carboxylic acid containing monomer or anhydride are contemplated, the amount of carboxylic group containing monomer present in the polymerizable monomer mixture ranges from about 60 to about 99 wt. %, and the amount of copolymerizable C₁-C₃₀ alkyl ester of (meth)acrylic acid monomer ranges from about 1 to about 40 wt. %, and the amount of optional polyunsaturated crosslinking monomer ranges from about 0.01 to about 5 wt. % based on the total weight of monomers in the polymerizable monomer mixture. In another aspect, the amount of optional polyunsaturated crosslinking monomer in the polymerizable monomer mixture can range from about 0.01 to 3.0 wt. %, or from about 0.05 to about 2.5 wt. %, or from about 0.1 to about 1 wt. %, or from about 0.3 to about 0.75 wt. % with the balance made up by the partially neutralized olefinically unsaturated carboxylic acid containing monomer or anhydride and the copolymerizable C₁-C₃₀ alkyl ester of (meth)acrylic acid monomer to total 100 wt. % of the monomer mixture.

In another aspect, the polymerizable monomer mixture comprises from about 70 to about 97 wt. % of the partially neutralized olefinically unsaturated carboxylic acid containing monomer or anhydride, from about 3 to about 30 wt. % of the copolymerizable C₁-C₃₀ alkyl ester of (meth)acrylic acid monomer, and from about 0.01 to about 5 wt. % of the optional polyunsaturated crosslinking monomer based on the total weight of monomers in the polymerizable monomer mixture. In another aspect, the amount of optional polyunsaturated crosslinking monomer in the polymerizable monomer mixture can range from about 0.01 to 3.0 wt. %, or from about 0.05 to about 2.5 wt. %, or from about 0.1 to about 1 wt. %, or from about 0.3 to about 0.75 wt. % with the balance made up by the partially neutralized olefinically unsaturated carboxylic acid containing monomer or anhydride and the copolymerizable C₁-C₃₀ alkyl ester of (meth)acrylic acid monomer to total 100 wt. % of the monomer mixture.

In another aspect, the polymerizable monomer mixture comprises from about 60 to about 99 wt. % partially neutralized (meth)acrylic acid, from about 1 to about 40 wt. %, of a copolymerizable C₁₀-C₃₀ alkyl ester of (meth)acrylic acid, and from about 0.01 to about 5 wt. %, or from about range from about 0.01 to 3.0 wt. %, or from about 0.05 to about 2.5 wt. %, or from about 0.1 to about 1 wt. %, or from about 0.3 to about 0.75 wt. % of at least one polyunsaturated crosslinking monomer, where the sum of all the monomers in said monomer mixture is 100 wt. %.

In another aspect, the polymerizable monomer mixture comprises from about 70 to about 97 wt. % of partially neutralized (meth)acrylic acid, from about 3 to about 30 wt. %, of a copolymerizable C₁₀-C₃₀ alkyl ester of (meth)acrylic acid, and from about 0.01 to about 5 wt. %, or from about range from about 0.01 to 3.0 wt. %, or from about 0.05 to about 2.5 wt. %, or from about 0.1 to about 1 wt. %, or from about 0.3 to about 0.75 wt. % of at least one polyunsaturated crosslinking monomer, where the sum of all the monomers in said monomer mixture is 100 wt. %.

In another aspect, the polymerizable monomer mixture comprises from about 70 to about 97 wt. % of partially neutralized (meth)acrylic acid, from about 3 to about 30 wt. %, of at least one copolymerizable C₁₀-C₃₀ alkyl ester of (meth)acrylic acid selected from In another aspect, the polymerizable monomer mixture comprises from about 70 to about 97 wt. % (meth)acrylic acid, from about 3 to about 30 wt. %, of a copolymerizable C₁₀-C₃₀ alkyl ester of (meth)acrylic acid, and from about 0.01 to about 5 wt. %, or from about range from about 0.01 to 3.0 wt. %, or from about 0.05 to about 2.5 wt. %, or from about 0.1 to about 1 wt. %, or from about 0.3 to about 0.75 wt. % of at least one polyunsaturated crosslinking monomer, where the sum of all the monomers in said monomer mixture is 100 wt. %, and from about 0.01 to about 5 wt. %, or from about range from about 0.01 to 3.0 wt. %, or from about 0.05 to about 2.5 wt. %, or from about 0.1 to about 1 wt. %, or from about 0.3 to about 0.75 wt. % of at least one polyunsaturated crosslinking monomer, where the sum of all the monomers in said monomer mixture is 100 wt. %.

In one aspect, the pulverulent partially neutralized carboxylic acid containing polymers of the present technology are prepared by conventional free radical precipitation polymerization of a monomer mixture comprising the partially neutralized olefinically unsaturated carboxylic acid containing monomer or anhydride, optionally at least one C₁-C₃₀ alkyl ester of (meth)acrylic acid, and optionally at least one polyunsaturated crosslinking monomer.

Initiators for the free radical polymerization of the partially neutralized carboxylic group containing monomers and optional copolymerizable monomers discussed above are the organic peroxides and hydroperoxides and/or azo compounds customarily employed for this purpose. Redox initiator systems can be employed as well. The initiators can be used in amounts up to 15 wt. % in one aspect, from 0.01 to 10 wt. % in another aspect, and from 0.2 to 5 wt. % in a further aspect, based on the total weight of the monomers to be polymerized. For initiators consisting of two or more constituents (e.g., in the case of redox initiator systems), the weights given above refer to the sum of the initiator components.

Exemplary initiators are, but are not limited to, hydrogen peroxide, diacetyl peroxide, di-tert-butyl peroxide, diamyl peroxide, dioctanoyl peroxide, di-decanoyl peroxide, dilauroyl peroxide, dibenzoyl peroxide, bis-(o-tolyl)peroxide, succinyl peroxide, methyl ethyl ketone peroxide, di-tert-butyl hydroperoxide, acetylacetone peroxide, di-(n-propyl) peroxydicarbonate, di-(iso-propyl) peroxydicarbonate, di-(sec-butyl) peroxydicarbonate, di-(2-ethylhexyl) peroxydicarbonate, di-(cyclohexyl) peroxydicarbonate, di-(cetyl) peroxydicarbonate, butyl peracetate, tert-butyl permaleinate, tert-butyl perisobutyrate, tert-butyl perpivalate, tert-butyl peroctoate, tert-butyl perneodecanoate, tert-butyl perbenzoate, tert-butyl hydroperoxide, cumene hydroperoxide, tert-butyl perneodecanoate, tert-amyl perpivalate, tert-butyl perpivalate, tert-butyl perbenzoate, tert-butyl peroxy-2-ethylhexanoate and diisopropyl peroxydicarbamate; also lithium, sodium, potassium and ammonium peroxodisulfate, 2,2′-azobisisobutyronitrile, 2,2′-azobis(2-methylbutyronitrile), 2,2′-azobis[2-methyl-N-(2-hydroxyethyl)]propionamide, 1,1′-azobis(1-cyclohexanecarbonitrile), 2,2′-azobis(2,4-dimethylvaleronitrile), 2,2′-azobis(N, N′-dimethyleneisobutyroamidine)dihydrochloride, and 2,2′-azobis(2-amidinopropane) dihydrochloride; and mixtures thereof. In one aspect, the initiator is selected from di-(2-ethylhexyl)peroxydicarbonate, dilauroyl peroxide, and mixtures thereof.

Redox initiator systems comprise at least one oxidizing, generally a peroxide compound and at least one reducing compound, for example, a reducing sulfur compound, selected from bisulfites, sulfites, thiosulfates, dithionites, tetrathionates of alkali metals or ammonium salts thereof or an organic reducing agent, such as benzoine, dimethylaniline, ascorbic acid, hydroxymethanesulfinates, and adducts of hydrogensulfite onto ketones, such as, for example, the acetone-bisulfite adduct.

The polymerization reactions are normally conducted in inert diluents that have solubilizing effect on one or more of the monomeric ingredients but substantially none on the resulting polymers. Stated differently, the medium used for the polymerization is a hydrocarbon solvent, or mixtures of a hydrocarbon solvent(s) with an organic solvent, in which the monomers are preferably soluble but in which the polymer is substantially insoluble, so that the polymer product is preferably obtained as a fine friable or fluffy precipitate which upon drying yields a pulverulent polymer product.

Representative hydrocarbon solvents include, but are not limited to, aromatic and substituted aromatic hydrocarbons such as benzene, ethylbenzene, toluene, xylene or the like; substituted or unsubstituted, straight or branched chain saturated aliphatic hydrocarbons of 5 or more carbon atoms, such as pentanes, hexanes, heptanes, octanes, and the like; alicyclic or substituted alicyclic hydrocarbons having 5 to 8 carbon atoms, such as cycloalkanes selected from cyclopentane, cyclohexane, cycloheptane, and cyclooctane, and the like; chlorinated hydrocarbons such as methylene chloride, chloroform, ethylene dichloride, 1,1,1-trichloroethane, trichloroethylene, perchloroethylene, and the like. Representative organic solvents include, but are not limited to, alkyl esters such as C₁-C₆ alkyl acetates and C₁-C₆ alkyl propionates selected from methyl acetate, ethyl acetate, propyl acetate, isopropyl acetate, butyl acetate, propyl propionate, butyl propionate and pentyl propionate; ketones such as acetone, methyl ethyl ketone, methyl isopropyl ketone, methyl isobutyl ketone, ethyl isopropyl ketone, 3-pentanone, cyclohexanone, and the like; and saturated alcohols containing 1 to 12 carbon atoms, such as, methanol, ethanol, propanol, isopropanol, butanol, iso-butyl alcohol, tert-butyl alcohol, 2-pentanol, and the like.

Mixtures of the hydrocarbon solvent(s) and the organic solvent(s) can be utilized in the polymerization medium. The mixed solvent system can be premixed, and the mixed reaction medium can be used in the polymerization reaction. The hydrocarbon solvent(s) and the organic solvent(s) can also be added separately to the reaction mixture and the polymerization reaction can be carried out thereafter. Whether the components of the reaction medium are premixed or are added separately to a reaction mixture is immaterial if the polymerization reaction is carried out in the presence of at least one organic solvent and at least one hydrocarbon solvent.

In one aspect, the amount of the hydrocarbon solvent, organic solvent or mixed hydrocarbon/organic solvent will normally be in excess of the monomer or monomers to be polymerized, and the proportion may vary from at least 1 wt. % monomers and 99 wt. % solvent to 50% monomers and 50% reaction medium. The amount of solvent used in the polymerization medium can range from about 50 to about 99 wt. % in one aspect, from about 60 to about 90 wt. % in another aspect, and from about 65 to about 80 wt. % in a further aspect, based on the total weight of the monomers to be polymerized and solvent.

In mixed hydrocarbon/organic solvent systems, the relative weight ratio of the at least one hydrocarbon solvent to the at least one organic solvent can be in the range of from about 95/5 to about 5/95 in one aspect, from about 80/20 to about 20/80 in another aspect, and from about 70/30 to about 30/70 in another aspect. In one aspect, the mixed hydrocarbon/organic solvent system comprises a cycloalkane and an alkyl ester (e.g., alkyl acetate, alkyl propionate). In one aspect, the mixed solvent system comprises cyclohexane and ethyl acetate.

Polymerization of the partially neutralized olefinic carboxyl group containing monomers, optionally with the other copolymerizable monomers described previously in the reaction medium is usually carried out in a closed vessel in an inert atmosphere and under atmospheric pressure, although it can proceed under reduced or elevated pressure, or in an open vessel under reflux at atmospheric pressure under an inert gaseous blanket. The temperature of the polymerization may be varied between about 0 and about 125° C. in one aspect, from about 40 to about 100° C. in another aspect, from about 45 to about 90° C. in a further aspect, and from about 60 to about 80° C. in a still further aspect, depending on the type of initiator selected.

In the practice of the technology, the polymerizations may be either batch, semi-batch or continuous. The agitation may be any agitation sufficient to maintain the slurry and obtain effective heat transfer including, for example, helical agitation, pitched turbines and the like. A useful reaction temperature range is from the range of 45 to 90° C. at about 1 atmosphere or more. Normal polymerization time is from about 3 to 12 hours.

The crosslinked partially neutralized carboxyl group containing homopolymers and copolymers of the present technology have weight average molecular weights ranging from about 10,000 to at least a billion Daltons in one aspect, and from about 100,000 to about 4.5 billion Daltons in another aspect, and from about 500,000 to about 3,000,000 Daltons in a further aspect, and from about 800,000 to about 1,000,000 Daltons in a still further aspect (see TDS-222, Oct. 15, 2007, Lubrizol Advanced Materials, Inc., which is herein incorporated by reference).

To obtain a polymer product with low residual monomer content, the initial polymerization step can be followed by a subsequent polymerization step. The subsequent polymerization step can take place in the presence of the same initiator system as employed in the initial polymerization or a different initiator system can be added. The subsequent polymerization step can be carried out at the same temperature as the initial polymerization or at a higher temperature. The initiator(s) will be sufficiently decomposed following its use in driving additional polymerization so little or no undesirable material is present in the polymer solution product.

The nascent polymer particles are dispersed throughout the reaction medium during the reaction but precipitate out of dispersion when fully converted to polymer in the reaction medium. The precipitated partially neutralized polymer can be isolated from the dispersion reaction mixture by any method known in the art for isolating polymers from a solvent such as, for example, filtration and/or centrifugation, followed by evaporation of the solvent by ambient air drying, oven drying, vacuum stripping, and the like, to obtain a dry partially neutralized polymer product in the form of a fine pulverulent solid.

In one aspect, the partially neutralized carboxylic acid group containing polymers of the present technology is prepared in the absence of steric stabilizers and/or wetting agents.

The method for wetting and dispersing the thickening polymers of the present technology comprises:
a) providing a pulverulent partially neutralized crosslinked carboxylic acid containing homopolymer or copolymer prepared from a monomer mixture comprising at least one olefinically unsaturated carboxylic acid group containing monomer, wherein from about 1 to about 15 wt. %, or from about 2 to about 10 wt. %, or from about 3 to about 8 wt. %, or from about 4 to about 6 wt. % of said carboxylic acid group containing monomer(s) in said mixture is neutralized;
b) adding said pulverulent partially neutralized carboxylic acid containing homopolymer or copolymer into an aqueous phase with mixing;
c) mixing a deswelling agent selected from an acid, a salt, and combinations thereof in said aqueous phase and allowing the partially neutralized to wet out and disperse;
d) optionally, adding a surfactant phase to the aqueous phase
e) optionally, adding an acid and/or base pH adjusting agent to said aqueous phase to adjust the pH of the partially neutralized crosslinked carboxylic acid containing homopolymer or copolymer.

Upon the addition of the deswelling agent to the aqueous phase containing the crosslinked partially neutralized carboxylic acid containing polymer or copolymer the particles begin to wet and form soft clusters of hydrated particles which sink below the surface of the water phase. Once the particles completely wet out (fully hydrate), they change from white powder to translucent particles and/or clusters of particles and begin to disperse throughout the water phase.

Pre-neutralized polycarboxylic acid homo- and copolymers tend to have a much higher polymer dispersion viscosity compared to conventional fully protonated polyacrylic acid homo- or copolymers. This substantially limits the use these pre-neutralized polymers in formulation applications. The advantage of adding a deswelling agent according to the method of the present technology is to reduce the polymer dispersion viscosity of a pre-neutralized polycarboxylic acid containing polymer, especially when formulations requiring higher concentrations 2 wt. %) of polymer solids are desired. The reduced dispersion viscosity allows efficient control over the blending of formulation components, shorter processing times, energy savings, and the use of higher concentration of polymer solids with less water.

If a more or less viscous rheology profile is desired, the pH of the formulation can be adjusted with an acidic and/or basic pH adjusting agent. To significantly increase the viscosity compositions formulated in accordance with the method of the present technology, the polymer contained in the composition can be further neutralized with an organic or inorganic base, causing the hydrated particles and clusters of hydrated particles to greatly expand in the aqueous phase, resulting in a smooth gel or highly viscous liquid.

Lower dispersion viscosities with the option to adjust viscosity after the formulation components have been mixed make it possible for a formulator to create products ranging from thin lotions to thicker creams using only a single rheology modifier. Current practice in the personal care industry is to use different carbomer polymers for lotions, creams and gels depending on the desired viscosity of the final product.

In a desired formulation, the amount of the at least one crosslinked partially neutralized carboxyl group containing homopolymer or copolymer employed in the method of the present technology will vary depending on the desired formulation. The amount of homopolymer or copolymer that is utilized in a formulation generally ranges from about 0.1 to about 10 wt. %, or from about 0.3 to about 5 wt. %, or from about 0.5 to about 3 wt. %, or from about 0.75 to 2.5 wt. %, or from about 0.8 to about 2 wt. %, or from about 0.9 to about 1.5 wt. % of active polymer (100% solids), based upon the total weight of the composition.

Suitable deswelling agents include inorganic acids, organic acids, inorganic and organic salts, and mixtures thereof. Exemplary inorganic acids include, but are not limited to, hydrochloric acid, nitric acid, sulfuric acid, sulfamic acid, phosphoric acid, and mixtures thereof. Exemplary organic acids include, but are not limited to, citric acid, acetic acid, alpha-hydroxy acid, beta-hydroxy acid, salicylic acid, lactic acid, glycolic acid, or natural fruit acids. Exemplary inorganic salts include, but are not limited to, sodium chloride, potassium chloride, lithium chloride, ammonium chloride, and mixtures thereof. Exemplary organic salts include but are not limited to, the alkali metal and ammonium salts of fatty acids. In one aspect, the salts of fatty acids include the sodium, potassium, lithium, and ammonium salts of a fatty acid wherein the acyl moiety of the fatty acid contains 8 to 22 carbon atoms, or 10 to 20 carbon atoms, or 12 to 18 carbon atoms. In one aspect, the salt of the fatty acid selected from the sodium, potassium, and ammonium salt of lauric, myristic, palmitic, steric acid, and mixtures thereof. In one aspect, the salt of the fatty acid selected from the sodium, potassium, and ammonium salt of coconut fatty acid.

The weight ratio of deswelling agent to the at least one crosslinked partially neutralized carboxyl group containing homopolymer or copolymer employed in the method of the present technology employed in the method of the present technology ranges from about 0.002:1 to about 20:1, or from about 0.1 to about 15:1, or from about 0.3:1 to about 10:1, or from about 0.5:1 to about 5:1, or from about 0.8:1 to about 2:1, or from about 0.9:1 to about 1:1.

Addition of the deswelling agent during the process of the present technology can be made at various points during the process. In one aspect, the deswelling agent can be added directly to the aqueous phase before the addition of the partially neutralized crosslinked carboxylic acid containing homopolymer or copolymer to the phase or after the addition of the partially neutralized carboxylic acid containing polymer or copolymer to the aqueous phase. In one aspect, the deswelling agent is added to the aqueous phase after the partially neutralized carboxylic acid containing polymer or copolymer is added to the aqueous phase.

After the addition of the deswelling agent and subsequent to wetting-out and homogeneously dispersing the pulverulent partially neutralized crosslinked carboxylic acid containing polymer or copolymer into the aqueous phase, the carboxyl or carboxylate groups on the polymer can be further neutralized or by addition of an alkaline or acidic pH adjusting agent to modify the rheology of the formulation. Ideally, the pH of the compositions formulated in accordance with the methodology of the present technology ranges from about 4.5 to about 10, or from about 5 to about 9.5, or from about 5.5 to about 9, or from about 6.0 to about 8.5, or from about 6.5 to about 7.5. Many types of neutralizing agents can be used in the method of the present technology, including inorganic and organic neutralizers. Examples of inorganic alkaline pH adjusting agents include but are not limited to the alkali metal and ammonium hydroxides (especially sodium, potassium, and ammonium). Examples of organic alkaline pH adjusting agents include but are not limited to, triethanolamine (TEA), L-arginine, aminomethyl propanol, tromethamine (2-amino 2-hydroxymethyl-1,3-propanediol), PEG-15 cocamine, diisopropanolamine, triisopropanolamine, or tetrahydroxypropyl ethylene diamine. Examples inorganic acidic pH adjusting agents include, but are not limited to, hydrochloric acid, nitric acid, sulfuric acid, sulfamic acid, phosphoric acid, and mixtures thereof. Examples of organic acidic pH adjusting agents include, but are not limited to, citric acid, acetic acid, alpha-hydroxy acid, beta-hydroxy acid, salicylic acid, lactic acid, glycolic acid, natural fruit acids, and mixtures thereof.

The aqueous phase is primarily water, usually deionized, distilled, or tap water (nominal hardness). In one aspect, the compositions prepared by the method of the present technology comprise from about 30 to about 99 wt. %, or from about 50 to about 95 wt. %, or from about 60 to about 90 wt. % or from about 70 to about 85 wt. % water.

An optional surfactant phase can be included in the compositions formulated in accordance with the method of the present technology. A surfactant phase selected from at least one anionic surfactant, at least one cationic surfactant, at least one amphoteric and/or a zwitterionic surfactant, at least one nonionic surfactant, and mixtures thereof can be included in the aqueous phase. In one aspect, the surfactant phase is mixed with the aqueous phase after the addition of the deswelling agent.

In one aspect, the method of the present technology utilizes an anionic surfactant. Suitable anionic surfactants include but are not limited to alkyl sulfates, alkyl ether sulfates, alkyl sulfonates, alkaryl sulfonates, α-olefin-sulfonates, alkylamide sulfonates, alkarylpolyether sulphates, alkylamidoether sulfates, alkyl monoglyceryl ether sulfates, alkyl monoglyceride sulfates, alkyl monoglyceride sulfonates, alkyl succinates, alkyl sulfosuccinates, alkyl ether sulfosuccinates, alkyl sulfosuccinamates, alkyl amidosulfosuccinates; alkyl sulfoacetates, alkyl phosphates, alkyl ether phosphates, alkyl ether carboxylates, alkyl amidoethercarboxylates, acyl lactylates, alkyl isethionates, acyl isethionates, carboxylate salts and amino acid derived surfactants such as N-alkyl amino acids, N-acyl amino acids, as well as alkyl peptides.

In one aspect, the cation moiety of the forgoing surfactants is selected from sodium, potassium, magnesium, ammonium, and alkanolammonium ions such as monoethanolammonium, diethanolammonium triethanolammonium ions, as well as monoisopropylammonium, diisopropylammonium and triisopropylammonium ions. In one embodiment, the alkyl and acyl groups of the foregoing surfactants contain from about 6 to about 24 carbon atoms in one aspect, from 8 to 22 carbon atoms in another aspect and from about 12 to 18 carbon atoms in a further aspect and may be unsaturated. The aryl groups in the surfactants are selected from phenyl or benzyl. The ether containing surfactants set forth above can contain from 1 to 10 ethylene oxide and/or propylene oxide units per surfactant molecule in one aspect, and from 1 to 3 ethylene oxide units per surfactant molecule in another aspect.

Examples of suitable anionic surfactants include the sodium, potassium, lithium, magnesium, and ammonium salts of laureth sulfate, trideceth sulfate, myreth sulfate, C₁₂-C₁₃ pareth sulfate, C₁₂-C₁₄ pareth sulfate, and C₁₂-C₁₅ pareth sulfate, ethoxylated with 1, 2, and 3 moles of ethylene oxide; the sodium potassium, lithium, magnesium, ammonium, and triethanolammonium salts of lauryl sulfate, coco sulfate, tridecyl sulfate, myristyl sulfate, cetyl sulfate, cetearyl sulfate, stearyl sulfate, oleyl sulfate, and tallow sulfate, disodium lauryl sulfosuccinate, disodium laureth sulfosuccinate, sodium cocoyl isethionate, sodium lauroyl isethionate, sodium lauroyl methyl isethionate, sodium C₁₂-C₁₄ olefin sulfonate, sodium laureth-6 carboxylate, sodium dodecylbenzene sulfonate, triethanolamine monolauryl phosphate, and fatty acid salts (soaps), including the sodium, potassium, ammonium, and triethanolamine salts of a saturated and unsaturated fatty acids containing from about 8 to about 22 carbon atoms.

In one aspect, the amino acid surfactants are selected from a N-acyl amino acid of the formula:

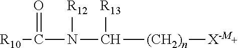

wherein R₁₀ is a saturated or unsaturated, straight or branched alkyl chain containing 7 to 17 carbon atoms, R₁₂ is H or a methyl group, R₁₃ is H, COO⁻M⁺, CH₂COO⁻M⁺ or COOH, n is 0 to 2, X is COO⁻ or SO₃⁻ and M independently represents H, sodium, potassium, ammonium or triethanolammonium.

In one aspect, the N-acyl amino acid surfactants represented by the formula immediately above are derived from taurates, glutamates, alanine, alaninates, sacosinates, aspartates, glycinates, and mixtures thereof.

Representative taurate surfactants conform to the formula:

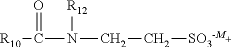

wherein R₁₀ is a saturated or unsaturated, straight or branched alkyl chain containing 7 to 17 carbon atoms in one aspect and 9 to 13 carbon atoms in another aspect, R₁₂ is H or methyl, and M is H, sodium, potassium, ammonium or triethanolammonium.

Non-limiting examples of taurate surfactants are potassium cocoyl taurate, potassium methyl cocoyl taurate, sodium caproyl methyl taurate, sodium cocoyl taurate, sodium lauroyl taurate, sodium methyl cocoyl taurate, sodium methyl lauroyl taurate, sodium methyl myristoyl taurate, sodium methyl oleoyl taurate, sodium methyl palmitoyl taurate, sodium methyl stearoyl taurate, and mixtures thereof.

Representative glutamate surfactants conform to the formula:

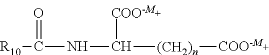

wherein R₁₀ is a saturated or unsaturated, straight or branched alkyl chain containing 7 to 17 carbon atoms in one aspect and 9 to 13 carbon atoms in another aspect, n is 0 to 2, and M independently is H, sodium, potassium, ammonium or triethanolammonium.

Non-limiting examples of glutamate surfactants are di-potassium capryloyl glutamate, di-potassium undecylenoyl glutamate, di-sodium capryloyl glutamate, di-sodium cocoyl glutamate, di-sodium lauroyl glutamate, di-sodium stearoyl glutamate, di-sodium undecylenoyl glutamate, potassium capryloyl glutamate, potassium cocoyl glutamate, potassium lauroyl glutamate, potassium myristoyl glutamate, potassium stearoyl glutamate, potassium undecylenoyl glutamate, sodium capryloyl glutamate, sodium cocoyl glutamate, sodium lauroyl glutamate, sodium myristoyl glutamate, sodium olivoyl glutamate, sodium palmitoyl glutamate, sodium stearoyl glutamate, sodium undecylenoyl glutamate, and mixtures thereof.

Representative alanine and alaninate surfactants conform to the formula:

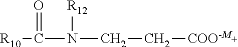

wherein R₁₀ is a saturated or unsaturated, straight or branched alkyl chain containing 7 to 17 carbon atoms in one aspect and 9 to 13 carbon atoms in another aspect, R₁₂ is H or methyl, and M is H, sodium, potassium, ammonium or triethanolammonium.

Non-limiting examples of alanine and alaninate surfactants are cocoyl methyl β-alanine, lauroyl β-alanine, lauroyl methyl β-alanine, myristoyl β-alanine, potassium lauroyl methyl β-alanine, sodium cocoyl alaninate, sodium cocoyl methyl β-alanine, sodium myristoyl methyl β-alanine, and mixtures thereof.

Representative glycinate surfactants conform to the formula:

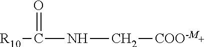

wherein R₁₀ is a saturated or unsaturated, straight or branched alkyl chain containing 7 to 17 carbon atoms in one aspect and 9 to 13 carbon atoms in another aspect, and M is H, sodium, potassium, ammonium or triethanolammonium.

Non-limiting examples of glycinate surfactants are sodium palmitoyl glycinate, sodium lauroyl glycinate, sodium cocoyl glycinate, sodium myristoyl glycinate, potassium lauroyl glycinate, potassium cocoyl glycinate, sodium stearoyl glycinate, and mixtures thereof.

Representative sarcosinate surfactants conform to the formula:

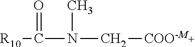

wherein R₁₀ is a saturated or unsaturated, straight or branched alkyl chain containing 7 to 17 carbon atoms in one aspect and 9 to 13 carbon atoms in another aspect, and M is H, sodium, potassium, ammonium or triethanolamine.

Non-limiting examples of sarcosinate surfactants are potassium lauroyl sarcosinate, potassium cocoyl sarcosinate, sodium cocoyl sarcosinate, sodium lauroyl sarcosinate, sodium myristoyl sarcosinate, sodium palmitoyl sarcosinate, and mixtures thereof.

Representative aspartate surfactants conform to the formula:

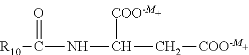

wherein R₁₀ is a saturated or unsaturated, straight or branched alkyl chain containing 7 to 17 carbon atoms in one aspect and 9 to 13 carbon atoms in another aspect, and M independently is H, sodium, potassium, ammonium or triethanolammonium.

Non-limiting examples of aspartate surfactants are sodium lauroyl aspartate, sodium myristoyl aspartate, sodium cocoyl aspartate, sodium caproyl aspartate, di-sodium lauroyl aspartate, di-sodium myristoyl aspartate, di-sodium cocoyl aspartate, di-sodium caproyl aspartate, potassium lauroyl aspartate, potassium myristoyl aspartate, potassium cocoyl aspartate, potassium caproyl aspartate, di-potassium lauroyl aspartate, di-potassium myristoyl aspartate, di-potassium cocoyl aspartate, di-potassium caproyl aspartate, and mixtures thereof.

In one aspect of the disclosed technology, the surfactant phase may comprise at least one fatty acid salt (soap) containing from about 8 to about 22 carbon atoms. In one aspect, the method utilizes as surfactant phase comprising at least one fatty acid salt (soap) containing from about 10 to 20 carbon atoms, or 12 to 18 carbon atoms.

In a further aspect of the disclosed technology the cleansing composition contains at least one fatty acid soap containing from about 12 to about 16 carbon atoms. Exemplary saturated fatty acids include, but are not limited to, the sodium, potassium, and ammonium salt of lauric, myristic, palmitic, steric acid, and mixtures thereof.

When fatty acid salts are utilized in the method of the present technology, they serve a dual function. On one hand they function as the anionic surfactant phase and on the other as a deswelling agent. In one aspect, when serving this dual function, the weight ratio of deswelling agent to partially neutralized crosslinked carboxylic acid containing homopolymer or copolymer ranges from about 5:1 to about 20:1, or from about 10:1 to about 15:1.

In one aspect of the present technology, suitable cationic surfactants include but are not limited to alkylamines, amidoamines, alkyl imidazolines, ethoxylated amines, quaternary compounds, and quaternized esters. In addition, alkylamine oxides can function as a cationic surfactant at a lower pH value.

Non-limiting examples of alkylamines and salts thereof include dimethyl cocamine, dimethyl palmitamine, dioctylamine, dimethyl stearamine, dimethyl soyamine, soyamine, myristyl amine, tridecyl amine, ethyl stearylamine, N-tallowpropane diamine, ethoxylated stearylamine, dihydroxy ethyl stearylamine, arachidylbehenylamine, dimethyl lauramine, stearylamine hydrochloride, soyamine chloride, stearylamine formate, N-tallowpropane diamine dichloride, and amodimethicone (INCI name for a silicone polymer and blocked with amino functional groups, such as aminoethylamino propylsiloxane).

Non-limiting examples of alkyl imidazoline surfactants include alkyl hydroxyethyl imidazoline, such as stearyl hydroxyethyl imidazoline, coco hydroxyethyl imidazoline, ethyl hydroxymethyl oleyl oxazoline, and the like.

Non-limiting examples of ethyoxylated amines include PEG-cocopolyamine, PEG-15 tallow amine, quaternium-52, and the like.

Exemplary quaternary ammonium surfactants include, but are not limited to cetyl trimethylammonium chloride, cetylpyridinium chloride, dicetyl dimethyl ammonium chloride, dihexadecyl dimethyl ammonium chloride, stearyl dimethyl benzyl ammonium chloride, dioctadecyl dimethyl ammonium chloride, dieicosyl dimethyl ammonium chloride, didocosyl dimethyl ammonium chloride, dihexadecyl dimethyl ammonium chloride, dihexadecyl dimethyl ammonium acetate, behenyl trimethyl ammonium chloride, benzalkonium chloride, benzethonium chloride, and di(cocoalkyl) dimethyl ammonium chloride, ditallowdimethyl ammonium chloride, di(hydrogenated tallow) dimethyl ammonium chloride, di(hydrogenated tallow) dimethyl ammonium acetate, ditallowdimethyl ammonium methyl sulfate, ditallow dipropyl ammonium phosphate, and ditallow dimethyl ammonium nitrate.

In one aspect of the present technology, suitable amphoteric surfactants include but are not limited to alkyl betaines, e.g., lauryl betaine; alkylamido betaines, e.g., cocamidopropyl betaine and cocohexadecyl dimethylbetaine; alkylamido sultaines, e.g., cocamidopropyl hydroxysultaine; (mono- and di-) amphocarboxylates, e.g., sodium cocoamphoacetate, sodium lauroamphoacetate, sodium capryloamphoacetate, disodium cocoamphodiacetate, disodium lauroamphodiacetate, disodium caprylamphodiacetate, disodium capryloamphodiacetate, disodium cocoamphodipropionate, disodium lauroamphodipropionate, disodium caprylamphodipropionate, and disodium capryloamphodipropionate; amine oxides, e.g., dimethyldodecylamine oxide, oleyldi(2-hydroxyethyl) amine oxide, dimethyltetradecylamine oxide, di(2-hydroxyethyl)-tetradecylamine oxide, dimethylhexadecylamine oxide, behenamine oxide, cocamine oxide, decyltetradecylamine oxide, dihydroxyethyl C₁₂₋₁₅ alkoxypropylamine oxide, dihydroxyethyl cocamine oxide, dihydroxyethyl lauramine oxide, dihydroxyethyl stearamine oxide, dihydroxyethyl tallowamine oxide, hydrogenated palm kernel amine oxide, hydrogenated tallowamine oxide, hydroxyethyl hydroxypropyl C₁₂-C₁₅ alkoxypropylamine oxide, lauramine oxide, myristamine oxide, cetylamine oxide, oleamidopropylamine oxide, oleamine oxide, palmitamine oxide, PEG-3 lauramine oxide, dimethyl lauramine oxide, potassium trisphosphonomethylamine oxide, soyamidopropylamine oxide, cocamidopropylamine oxide, stearamine oxide, tallowamine oxide, and mixtures thereof, and mixtures thereof.

The foregoing amphoteric surfactants (i.e., the betaines and sultaines are disclosed without a counter ion, as one of ordinary skill in the art will recognize that the under the pH conditions of the compositions containing the amphoteric surfactants, these surfactants are either electrically neutral by virtue of having balancing positive and negative charges, or they contain counter ions such as alkali metal, alkaline earth or ammonium ions as a charge balancing moiety.

In one aspect, the nonionic surfactant is an alcohol alkoxylate derived from a saturated or unsaturated fatty alcohol containing 8 to 18 carbon atoms, and the number of alkylene oxide groups present in the alcohol range from about 3 to about 12. The alkylene oxide moiety is selected from ethylene oxide, propylene oxide and combinations thereof. In another aspect, the alcohol alkoxylate is derived from a fatty alcohol containing 8 to 15 carbon atoms and contains from 5 to 10 alkoxy groups (e.g., ethylene oxide, propylene oxide, and combinations thereof). Exemplary nonionic fatty alcohol alkoxylate surfactants in which the alcohol residue contains 12 to 15 carbon atoms and contain about 7 ethylene oxide groups are available under the Tomadol® (e.g., product designation 25-7) and Neodol® (e.g., product designation 25-7) trade names from Evonik Industries AG and Shell Chemicals, respectively.

An exemplary nonionic alcohol alkoxylated surfactant derived from an unsaturated fatty alcohol and containing about 10 ethylene oxide groups is available from Lubrizol Advanced Materials, Inc. under the trade Chemonic™ oleth-10 ethoxylated alcohol.

Another commercially available alcohol alkoxylate surfactant is sold under the Plurafac® trade name from BASF. The Plurafac surfactants are reaction products of a higher linear alcohol and a mixture of ethylene and propylene oxides, containing a mixed chain of ethylene oxide and propylene oxide, terminated by a hydroxyl group. Examples include C₁₃ to C₁₅ fatty alcohols condensed with 6 moles ethylene oxide and 3 moles propylene oxide, C₁₃ to C₁₅ fatty alcohols condensed with 7 moles propylene oxide and 4 moles ethylene oxide, and C₁₃ to C₁₅ fatty alcohols condensed with 5 moles propylene oxide and 10 moles ethylene oxide.

Another commercially suitable nonionic surfactant is available from Shell Chemicals under the Dobanol™ trade name (product designations 91-5 and 25-7). Product designation 91-5 is an ethoxylated C₉ to C₁₁ fatty alcohol with an average of 5 moles ethylene oxide and product designation 25-7 is an ethoxylated C₁₂ to C₁₅ fatty alcohol with an average of 7 moles ethylene oxide per mole of fatty alcohol.

Another commercially suitable nonionic surfactant is available from Shell Chemicals under the Dobanol™ trade name (product designations 91-5 and 25-7). Product designation 91-5 is an ethoxylated C₉ to C₁₁ fatty alcohol with an average of 5 moles ethylene oxide and product designation 25-7 is an ethoxylated C₁₂ to C₁₅ fatty alcohol with an average of 7 moles ethylene oxide per mole of fatty alcohol.

Other surfactants which can be utilized in the method of the present technology are set forth in more detail in WO 99/21530, U.S. Pat. Nos. 3,929,678, 4,565,647, 5,456,849, 5,720,964, 5,858,948, and 7,115,550, which are herein incorporated by reference. Additionally, suitable surfactants are described in McCutcheon's Emulsifiers and Detergents (North American and International Editions, by Schwartz, Perry and Berch) which is hereby fully incorporated by reference.

In one aspect, the surfactant(s) utilized in the method of the present technology can be employed in amounts typically utilized in personal care cleansing compositions. In one aspect, the at least one surfactant is utilized in an amount ranging from about 2 to about 35 wt. %, or from about 5 to about 30 wt. %, or from about 7 to about 25 wt. %, or from about 9 to about 20 wt. %, or from about 12 to about 15 wt. %, based on the total weight of the total composition.

In one aspect, the surfactant is selected from a combination of an anionic surfactant and an amphoteric surfactant. In one aspect, the weight ratio of anionic surfactant to amphoteric surfactant (based on the active material) is from about 10:1 to about 2:1 in one aspect, and 9:1, 8:1, 7:1 6:1, 5:1, 4.5:1, 4:1, or 3:1 in another aspect.

In one aspect, a cationic polymer can be formulated into compositions prepared by the method of the present technology. Cationic polymers are components that can enhance the delivery of conditioning agents and/or provide auxiliary conditioning benefits to the hair, scalp or skin to improve and enhance the conditioning benefits delivered by the silicone conditioning agents of the disclosed technology. Cationic polymer refers to polymers containing at least one cationic moiety or at least one moiety that can be ionized to form a cationic moiety. Typically, these cationic moieties are nitrogen containing groups such as quaternary ammonium or protonated amino groups. The cationic protonated amines can be primary, secondary, or tertiary amines. The cationic polymer typically has a cationic charge density ranging from about 0.2 to about 7 meq/g at the pH of the intended use of the composition. The average molecular weight of the cationic polymer ranges from about 5,000 daltons to about 10,000,000 daltons.

Non-limiting examples of such polymers are described in the CTFA International Cosmetic Ingredient Dictionary/Handbook via the CTFA website as well as the CTFA Cosmetic Ingredient Handbook, Ninth Ed., Cosmetic and Fragrance Assn., Inc., Washington D.C. (2002), incorporated herein by reference, can be used.

Non-limiting examples of suitable cationic polymers include copolymers of vinyl monomers having cationic protonated amine or quaternary ammonium functionalities with water soluble spacer monomers such as acrylamide, methacrylamide, alkyl and dialkyl acrylamides, alkyl and dialkyl methacrylamides, alkyl acrylate, alkyl methacrylate, vinyl caprolactone or vinyl pyrrolidone.

Suitable cationic protonated amino and quaternary ammonium monomers, for inclusion in the cationic polymers of the composition herein, include vinyl compounds substituted with dialkylaminoalkyl acrylate, dialkylaminoalkyl methacrylate, monoalkylaminoalkyl acrylate, monoalkylaminoalkyl methacrylate, trialkyl methacryloxyalkyl ammonium salt, trialkyl acryloxyalkyl ammonium salt, diallyl quaternary ammonium salts, and vinyl quaternary ammonium monomers having cyclic cationic nitrogen-containing rings such as pyridinium, imidazolium, and quaternized pyrrolidone, e.g., alkyl vinyl imidazolium, alkyl vinyl pyridinium, alkyl vinyl pyrrolidone salts.

Other suitable cationic polymers for use in the compositions include copolymers of 1-vinyl-2-pyrrolidone and 1-vinyl-3-methylimidazolium salt (e.g., chloride salt) (CTFA, Polyquaternium-16); copolymers of 1-vinyl-2-pyrrolidone and dimethylaminoethyl methacrylate (CTFA, Polyquaternium-11); cationic diallyl quaternary ammonium-containing polymers, including, for example, dimethyldiallylammonium chloride homopolymer, copolymers of acrylamide and dimethyldiallylammonium chloride (CTFA, Polyquaternium-6 and Polyquaternium-7, respectively); amphoteric copolymers of acrylic acid including copolymers of acrylic acid and dimethyldiallylammonium chloride (CTFA, Polyquaternium-22); terpolymers of acrylic acid with dimethyldiallylammonium chloride and acrylamide (CTFA, Polyquaternium-39); terpolymers of acrylic acid with methacrylamidopropyl trimethylammonium chloride and methylacrylate (CTFA, Polyquaternium-47); terpolymers of acrylic acid, methacrylamidopropyl trimethylammonium chloride and acrylamide (CTFA, Polyquaternium-53). In one aspect, suitable cationic substituted monomers are the cationic substituted dialkylaminoalkyl acrylamides, dialkylaminoalkyl methacrylamides, and combinations thereof.

Other suitable cationic polymers for use in the composition include polysaccharide polymers, such as cationic cellulose derivatives and cationic starch derivatives modified with a quaternary ammonium halide moiety. Exemplary cationic cellulose polymers are salts of hydroxyethyl cellulose reacted with trimethyl ammonium substituted epoxide (CTFA, Polyquaternium-10). Other suitable types of cationic cellulose include the polymeric quaternary ammonium salts of hydroxyethyl cellulose reacted with lauryl dimethyl ammonium substituted epoxide (CTFA, Polyquaternium-24).

Other suitable cationic polymers include cationic polygalactomannan derivatives such as guar gum derivatives and cassia gum derivatives, e.g., guar hydroxypropyltrimonium chloride and cassia hydroxypropyltrimonium chloride, respectively. Guar hydroxypropyltrimonium chloride is commercially available under the Jaguar™ trade name series from Rhodia Inc. and the N-Hance trade name series from Ashland Inc. Cassia hydroxypropyltrimonium chloride is commercially available under the Sensomer™ trade name series from Lubrizol Advanced Materials, Inc.

The amount of cationic polymer that may be utilized in the cleansing compositions of the disclosed technology range from about 0.01 to about 10 wt. % in one aspect, from about 0.05 to about 3 wt. % in another aspect, and from about 0.1 to about 1 wt. % in a further aspect, based on the weight of the total composition.

While overlapping weight ranges for the various components and ingredients that can be contained compositions prepared by the method of the present technology have been expressed for selected embodiments and aspects of the invention, it should be readily apparent that the specific amount of each component in the compositions will be selected from its disclosed range such that the amount of each component is adjusted so that the sum of all components in the composition will total 100 weight percent. The amounts employed will vary with the purpose and character of the desired product and can be readily determined by one skilled in the formulation art and from the literature.

In one aspect, a preservative can be formulated into compositions prepared by the method of the present technology. Suitable preservatives and antimicrobial agents, if present, include polymethoxy bicyclic oxazolidine, methyl paraben, propyl paraben, ethyl paraben, butyl paraben, benzoic acid and the salts of benzoic acid, e.g., sodium benzoate, benzyltriazole, DMDM hydantoin (also known as 1,3-dimethyl-5,5-dimethyl hydantoin), phnimidazolidinyl urea, phenoxyethanol, phenoxyethylparaben, methylisothiazolinone, methylchloroisothiazolinone, benzoisothiazolinone, triclosan, sorbic acid, salicylic acid salts, and the like, and mixtures thereof. Preservatives typically comprise about 0.01 wt. % to about 1.5 wt. % of the total wt. of the personal care compositions of the present invention.

The present technology is exemplified by the following examples that are merely for the purpose of illustration and are not to be regarded as limiting the scope of the technology or the way it can be practiced. The amount of all ingredients reported in the tables in the Examples is “as supplied” by the manufacturer. Any ingredient not supplied as 100 percent active material is identified by the active material percentage as supplied by the manufacturer. To calculate the amount of active ingredient utilized in the exemplified composition, multiply the active material percent by the total amount (as supplied) for an ingredient. For example, if an ingredient as supplied by the manufacturer contains 30 wt. % of active polymer material (the remainder is inert carrier).

### Test Methodology

### Viscosity Determination

Brookfield rotating spindle method (all viscosity measurements reported herein are conducted by the Brookfield method whether mentioned or not): The viscosity measurements are calculated in mPa·s, employing a Brookfield rotating spindle viscometer, Model RVT (Brookfield Engineering Laboratories, Inc.), at about 20 revolutions per minute (rpm), at ambient room temperature of about 20 to 25° C. (hereafter referred to as viscosity). Spindle sizes are selected in accordance with the standard operating recommendations from the manufacturer. Generally, spindle sizes are selected as follows:

| Spindle Size No. | Viscosity Range (mPa · s) |
|---|---|
| 1 | 1-50 |
| 2 | 500-1,000 |
| 3 | 1,000-5,000 |
| 4 | 5,000-10,000 |
| 5 | 10,000-20,000 |
| 6 | 20,000-50,000 |
| 7 | >50,000 |

The spindle size recommendations are for illustrative purposes only. The artisan of ordinary skill in the art will select a spindle size appropriate for the system to be measured.

### Yield Value Determination

Yield Value, also referred to as Yield Stress, is defined as the initial resistance to flow under stress. It is measured by the Brookfield Yield Value (BYV) Extrapolation Method using a Brookfield viscometer (Model RVT) at ambient room temperature of about 20 to 25° C. The Brookfield viscometer is used to measure the torque necessary to rotate a spindle through a liquid sample at speeds of 0.5 to 100 rpm. Multiplying the torque reading by the appropriate constant for the spindle and speed gives the apparent viscosity. Yield Value is an extrapolation of measured values to a shear rate of zero. The BYV is calculated by the following equation:

BYV, dyn/cm²=(η_{π1}−η_{α2})/100

where η_{α1} and η_{α2}=apparent viscosities obtained at two different spindle speeds (0.5 rpm and 1.0 rpm, respectively). These techniques and the usefulness of the Yield Value measurement are explained in Technical Data Sheet Number 244 (Revision: 5/98) from Noveon Consumer Specialties of Lubrizol Advanced Materials, Inc., herein incorporated by reference.

### Clarity Measurement

The clarity (turbidity) of a composition is determined in Nephelometric Turbidity Units (NTU) employing a nephelometric turbidity meter (Micro 100 Turbidimeter, HF Scientific, Inc.) at ambient room temperature of about 20 to 25° C. Distilled water (NTU=0) is utilized as a standard. Six-dram screw cap vials (70 mm×25 mm) are filled almost to the top with test sample and centrifuged at 100 rpm until all bubbles are removed. Upon centrifugation, each sample vial is wiped with tissue paper to remove any smudges before placement in the turbidity meter. The sample is placed in the turbidity meter and a reading is taken. Once the reading stabilizes the NTU value is recorded. The vial is given one-quarter turn and another reading is taken and recorded. This is repeated until four readings are taken. The lowest of the four readings is reported as the turbidity value. Compositions having an NTU value of about 50 or greater were judged hazy or turbid.

### Example 1

A crosslinked partially neutralized carboxyl group containing copolymer was prepared in a one liter closed 4-necked water-jacketed Pyrex® glass resin kettle reactor equipped with a propylene glycol-cooled condenser, a temperature controlled water bath reservoir and circulation pump, a nitrogen sparge tube and a Caframo® overhead stirrer (model no. BDC1850) outfitted with a stainless steel stirring shaft configured with a lower H-shaped mixing blade situated 1 in. above the reactor bottom and an upper propeller mixer situated 2 in. above the reactor bottom. The stirring shaft configuration is described in U.S. Pat. No. 9,725,589. A monomer mixture comprising 113 grams of acrylic acid, 5.95 grams of stearyl methacrylate (SMA), 0.48 grams of allyl pentaerythritol (APE), and 3.57 grams of ammonium carbonate was subsequently added into the reactor. Approximately 4.7% of the acrylic acid monomer was neutralized. Then, 665.29 grams of cyclohexane and 237.98 grams of ethyl acetate were added to the reactor followed by sparging nitrogen gas through the medium with stirring at 250 rpm. The nitrogen sparge is continued for 30-min. during which time the reactor contents are heated to 45° C. by circulating water from the pre-heated water bath through the water-jacketed reactor. Another 1.19 grams of 10% di(2-ethylhexyl) peroxydicarbonate solution in ethyl acetate was added as initiator to the reactor via a syringe after which the sparge tube was raised out of the reaction medium and into the head space of the closed reactor to maintain an inert gaseous blanket over the reaction medium. another 1.19 grams of 10% di(2-ethylhexyl) peroxydicarbonate solution in ethyl acetate was added after the 4 hours of the reaction as well as 52.5 grams of cyclohexane and 22.5 grams of ethyl acetate. The temperature of the polymerization reaction was kept at 45° C. for 2 hours. The polymerization was then conducted at an elevated temperature (55° C.) for 1 hour, after which, the temperature was increased to 60° C. and the reaction was kept at 60° C. for an additional 4 hours. The polymer dispersion was then cooled to ambient temperature and removed from the reactor, solvent and any residual monomer was stripped under vacuum at 80° C. resulting in a dry pulverulent powder as the final product.

### Example 2

A crosslinked un-neutralized carboxyl group containing copolymer was prepared in a one liter closed 4-necked water-jacketed Pyrex® glass resin kettle reactor equipped with a propylene glycol-cooled condenser, a temperature controlled water bath reservoir and circulation pump, a nitrogen sparge tube and a Caframo® overhead stirrer (Model No. BDC1850) outfitted with a stainless steel stirring shaft configured with a lower H-shaped mixing blade situated 1 in. above the reactor bottom and an upper propeller mixer situated 2 in. above the reactor bottom. The stirring shaft configuration is described in U.S. Pat. No. 9,725,589. 95.0 grams of acrylic acid, 5.0 grams of stearyl methacrylate (SMA), and 0.35 grams of allyl pentaerythritol (APE), were subsequently added into the reactor. Then, 371.64 grams of cyclohexane and 436.28 grams of ethyl acetate were added to the reactor followed by sparging nitrogen gas through the medium with stirring at 250 rpm. The nitrogen sparge is continued for 30-min. during which time the reactor contents are heated to 50° C. by circulating water from the pre-heated water bath through the water-jacketed reactor. 2.0 grams of 10% di(2-ethylhexyl) peroxydicarbonate solution in ethyl acetate was added as initiator to the reactor via a syringe after which the sparge tube is raised out of the reaction medium and into the head space of the closed reactor to maintain an inert gaseous blanket over the reaction medium. Another 2.0 grams of 10% di(2-ethylhexyl) peroxydicarbonate solution in ethyl acetate was added after the 8 hours of the reaction. The temperature of the polymerization reaction was kept at 50° C. for another 16 hours. The polymer dispersion was then cooled to ambient temperature and removed from the reactor, the solvent and any residual monomer was stripped under vacuum at 80° C. resulting in a dry pulverulent powder as the final product.

### Example 3

A crosslinked partially neutralized carboxyl group containing homopolymer was prepared in a one liter closed 4-necked water-jacketed Pyrex® glass resin kettle reactor equipped with a propylene glycol-cooled condenser, a temperature controlled water bath reservoir and circulation pump, a nitrogen sparge tube and a Caframo® overhead stirrer (Model No. BDC1850) outfitted with a stainless steel stirring shaft configured with a lower H-shaped mixing blade situated 1 in. above the reactor bottom and an upper propeller mixer situated 2 in. above the reactor bottom. The stirring shaft configuration is described in U.S. Pat. No. 9,725,589. A monomer mixture comprising 139.29 grams of acrylic acid, 5.57 grams of potassium carbonate, and 0.28 grams of allyl pentaerythritol (APE), were subsequently added into the reactor. Then, 781.14 grams of ethyl acetate were added to the reactor followed by sparging nitrogen gas through the medium with stirring at 250 rpm. The nitrogen sparge was continued for 30-min. during which time the reactor contents are heated to 55° C. by circulating water from the pre-heated water bath through the water-jacketed reactor. 1.39 grams of 10% di(2-ethylhexyl) peroxydicarbonate solution in ethyl acetate was added as initiator to the reactor via a syringe after which the sparge tube was raised out of the reaction medium and into the head space of the closed reactor to maintain an inert gaseous blanket over the reaction medium. Another 2.79 grams of 10% di(2-ethylhexyl) peroxydicarbonate solution in ethyl acetate was added after the 6 hours of the reaction. After adding additional 75 grams of ethyl acetate, the temperature of the polymerization reaction was kept at 55° C. for another 6 hours. Then, the polymer dispersion was cooled to ambient temperature and removed from the reactor. The solvent and residual monomer was stripped under vacuum resulting dry pulverulent powder as the final product.

### Example 4

A dispersion of the polymer of Example 1 was made in a 400 ml beaker equipped with a single three-blade marine blade impeller on a Caframo® mixer. 10 grams of HCl (36.5%) was added into 90 grams of deionized (DI) water to make 3.65% HCl solution. 196 grams of water was weighed into a 400 ml beaker. 0.55 grams of diluted HCl (3.65%) solution was then added and mixed well with the water in the beaker. 4 grams of polymer powder were slowly added into the beaker, while the solution was stirred at 400 rpm. The stirring speed was increased to 800-1000 rpm to ensure efficient dispersion and mixing. The dispersion time was recorded from the addition of powder till the polymer powders were fully hydrated and no white particles were observed. The viscosity of the resulted polymer dispersion was measured using Brookfield Viscometer at 20 rpm. The results are set forth in Table 1.

TABLE 1

| | Polymer | | | Dispersion |
|---|---|---|---|---|
| | Concentration | HCl:Polymer | Dispersion | Viscosity |
| Polymer Ex. | (wt. %) | (wt. ratio) | Time¹ (min.) | (mPa · s) |
| 1 | 2 | 0 | 15 | 48,200 |
| 1 | 2 | 0.005:1 | 19 | 29,200 |
| 2 | 1 | 0 | 143 | 1,215 |

¹Dispersion time is the time interval between the initial addition of the polymer to the aqueous phase and the point at which the polymer particles become totally translucent.

As demonstrated by the results set forth in TABLE 1, formulating with partially neutralized crosslinked carboxyl group containing copolymer in conjunction with a deswelling agent (HCl), results in a relatively short dispersion time and significantly reduced dispersion viscosity compared to formulating a partially neutralized crosslinked carboxyl group containing copolymer and an un-neutralized crosslinked carboxyl group containing copolymer without a deswelling agent.

### Examples 5 to 7

Personal care compositions comprising the components set forth in TABLE 2 were formulated according to the method of the present invention. Dispersion times and dispersion viscosities as well as and other rheological properties of the formulated compositions according to the technology are set forth in TABLE 3.

TABLE 2

| | | Control | Ex. 5 | Ex. 6 | Ex. 7 |
|---|---|---|---|---|---|
| | | Wt % | Wt % | Wt % | Wt % |
| | | As supplied | As supplied | As supplied | As supplied |
| Phase | INCI | (total solids) | (total solids) | (total solids) | (total solids) |
| A | DI Water | To 100 | To 100 | To 100 | To 100 |
| | Polymer of Ex. 1 | 1 | 1 | 1 | 1 |
| B | 50% Citric Acid | — | 0.65 (0.325) | 1.2 (0.6) | — |
| | Solution | | | | |
| | 25% Sodium Chloride | — | — | — | 1.2 (0.3) |
| C | Disodium Cocoyl | 32 (8) | 32 (8) | 32 (8) | 32 (8) |
| | Glutamate (20%), | | | | |
| | Sodium Cocoyl | | | | |
| | Glutamate (5%) and | | | | |
| | Aqua (75%) | | | | |
| | Sodium | 13.9 (5) | 13.9 (5) | 13.9 (5) | 13.9 (5) |
| | Lauroamphoacetate | | | | |
| | (36%), Sodium | | | | |
| | Chloride (6.5%) and | | | | |
| | Aqua | | | | |
| | Cocamidopropyl | 10 (3) | 10 (3) | 10 (3) | 10 (3) |
| | Betaine (30%), | | | | |
| | Sodium Chloride (5%) | | | | |
| | and Aqua | | | | |
| | Ethylhexyl Glycerine | 1 | 1 | 1 | 1 |
| | (and) Phenoxyethanol | | | | |
| D | 50% Citric Acid | 0.65 (0.325) | — | — | 0.6 (0.3) |
| | Solution | | | | |
| | 18% Sodium | — | — | 0.53 (0.1) | — |
| | Hydroxide Solution | | | | |

The compositions were formulated as follows:
1. Mix the pulverulent polymer powder in DI water at 25° C. with stirring (IKA Eurostar 20 high speed mixer) at 400 rpm to give phase A.
2. Add phase B into phase A with stirring at 400 rpm to depress viscosity.
3. Add the mixture of phase (A+B) into phase C, stir at 25° C. with stirring at 400 rpm for 15-min. to obtain a thick gel (IKA Eurostar 20 high speed mixer).
4. Adjust pH with phase D to pH=5.8 to 6.2.

TABLE 3

| | Target | | | | |
|---|---|---|---|---|---|
| | Value | Control | Ex. 5 | Ex. 6 | Ex. 7 |
| Dispersion Time (Min) | <30 | 5 | 5 | 5 | 5 |
| Viscosity of Phase A | | 86,000 | 86,000 | 86,000 | 86,000 |
| Viscosity of Phase | <8000 | N.A. | 30 | 21.5 | 7 |
| (A + B) (mPa · s) | | | | | |
| Ph | 5.8-6.2 | 6.07 | 5.91 | 5.83 | 5.93 |
| Viscosity of Final | >2000 | 3770 | 2815 | 2140 | 2605 |
| Formulation (mPa · s) | | | | | |
| Turbidity (NTU) | <20 | 6.75 | 6.86 | 7.46 | 7.48 |
| Yield Value | >100 | 167 | 208 | 155 | 206 |
| (Dyne/cm²) | | | | | |

The results demonstrate that the dispersion viscosity (viscosity of phase (A+B)) can be significantly reduced when employing the deswell methodology (acid or salt) of the present technology. The deswell method does not cause significant differences in the viscosity, turbidity and yield of the final formulation.

### Example 8

A personal care formulation was prepared according to the method of the present technology form the components set forth in TABLE 4. The final rheology properties of the formulated composition are set forth in TABLE 5.

TABLE 4

| | | Ex. 8 |
|---|---|---|
| | | Wt % |
| | | As Supplied |
| Phase | INCI | (Total Solids) |
| A | Deionized Water | To 100 |
| | Polymer of Ex. 1 | 0.8 |
| B | 50% citric acid solution | 1.88 (0.94) |
| C | Sodium Lauroyl Sarcosinate (30% | 26.7 (8) |
| | Active) | |
| | Sodium Lauroamphoacetate (36% TS) | 13.9 (5) |
| | Cocamidopropyl Betaine (35% TS) | 8.6 (3) |
| D | Polyquaternium-39 (11%) | 2 (0.22) |
| | Ethylhexyl Glycerin (and) | 0.2 |
| | Phenoxyethanol | |
| | Sodium Benzoate | 0.3 |

The composition was formulated as follows:
1. Mix pulverulent polymer with DI water at 400 rpm at 25° C. with stirring (IKA Eurostar 20 high speed mixer) at 400 rpm to obtain phase A.
2. Add citric acid into phase A with stirring (IKA Eurostar 20 high speed mixer) at 400 rpm to give a translucent fluid liquid.
3. Add the mixture of phase (A+B) into phase C with stirring (IKA Eurostar 20 high speed mixer) at 400 rpm at 25° C. obtaining a thick gel.
4. Add phase D in the order of listed components into phase C with mixing (IKA Eurostar 20 high speed mixer) at 400 rpm at 25° C.

TABLE 5

| | Target Value | Ex. 7 |
|---|---|---|
| pH | 5.1-5.5 | 5.38 |
| Viscosity of final formulation | >20000 | 46200 |
| (mPa · s) | | |
| Yield Value (dyne/cm²) | >100 | 240 |

The results demonstrate the performance of the pre-neutralized polymer in a 3 component surfactant chassis formulated in accordance with the method of the present technology.

### Example 8

A personal care composition was formulated in a fatty acid salt (soap) surfactant chassis from the components set forth in TABLE 6. The final rheology properties of the formulated composition are set forth in TABLE 7.

TABLE 6

| | | Ex, 8 |
|---|---|---|
| | | Wt % |
| Phase | INCI | As Supplied (Total Solid) |
| A | Lauric Acid | 10 |
| | Myristic Acid | 5 |
| B | Polymer of Ex. 1 | 0.9 |
| C | Glycerin | 5 |
| | Deionized Water | 66.94 |
| | Disodium EDTA | 0.1 |
| | Potassium Hydroxide (85%) | 4.91 |
| | Coca Betaine (43%) | 4.65 |
| | Decyl Glucoside (50%) | 2 |
| | Ethylhexyl Glycerine (and) | 0.5 |
| | Phenoxyethanol | |

The composition was formulated as follows:
1. Phase A heat fatty acid in water bath at 80° C. to melt.
2. Add phase B polymer into Phase A and stir at 200 rpm.
3. Mix components of phase C at room temperature and heat to 80° C. Add mixture of phase (A+B) into phase C with stirring (IKA Eurostar 20 high speed mixer) at 550 rpm and saponify for 30 min. Cool mixture to room ambient room temperature (20-23° C.) with stirring (IKA Eurostar 20 high speed mixer) at 200 rpm.

TABLE 7

| | Target Value | Example 8 |
|---|---|---|
| pH | 9.5-9.9 | 9.61 |
| Viscosity of final formulation | >2000 | 2175 |
| (mPa · s) | | |
| Yield Value (dyne/cm²) | >50 | 51 |

The results demonstrate that a fatty acid salt serves a dual function as a surfactant chassis and a deswelling agent.

### Example 9

The crosslinked acrylic acid homopolymer of Example 3 was formulated utilizing the same methodology as set forth in Example 4, except that the deswelling agents and amounts illustrated in Table 8 were used. Dispersion times and dispersion viscosities are also reported in the table.

TABLE 8

| | | 2 wt. % Polymer | 2 wt. % Polymer Dispersion |
|---|---|---|---|
| Polymer | Swelling Agent:Polymer | Dispersion Time¹ | Viscosity |
| Ex. | (wt. ratio) | (min.) | (mPa · s) |
| 3 | 0 | 150 | 6360 |
| 3 | 0.005:1 | 82 | 5900 |
| | (citric acid:polymer) | | |
| 3 | 0.025:1 | 65 | 56 |
| | (HCl:polymer) | | |

¹Dispersion time is the time interval between the initial addition of the polymer to the aqueous phase and the point at which the polymer particles become totally translucent.

The results indicate that partial neutralization and a deswelling agent are necessary to decrease dispersion times and to reduce dispersion viscosities.

1. A method for wetting and dispersing a pulverulent polycarboxylic acid containing polymer in aqueous media comprising:
a) providing a pulverulent partially neutralized carboxylic acid containing polymer or copolymer, wherein said polymer or copolymer is prepared from a monomer mixture comprising at least one olefinically unsaturated carboxylic acid group containing monomer, and wherein from about 1 to about 15 wt. %, or from about 2 to about 10 wt. %, or from about 3 to about 8 wt. %, or from about 4 to about 6 wt. % of said carboxylic acid group containing monomer(s) is neutralized;
b) mixing said pulverulent partially neutralized carboxylic acid containing polymer or copolymer in an aqueous medium; and
c) mixing a deswelling agent selected from an acid, a salt, and combinations thereof with said aqueous medium.

2. A method of claim 1, wherein said olefinically unsaturated carboxylic acid group containing monomer is selected from acrylic acid, methacrylic acid, 2-carboxyethyl acrylate, maleic acid, maleic anhydride, itaconic acid, and mixtures thereof.

3. A method of claim 1, wherein said monomer mixture comprises at least one C₁-C₃₀ alkyl ester of (meth)acrylic acid of the formula: 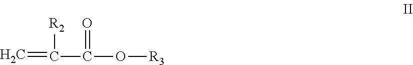
wherein R₂ is selected from hydrogen, methyl and ethyl; R₃ is an alkyl group containing 1 to 30 carbon atoms, or 10 to 30 carbon atoms, or 2 to 20 carbon atoms, or 2 to 18 carbon atoms.

4. A method of claim 1, wherein said monomer mixture comprises at least one acrylic acid ester monomer selected from methyl (meth)acrylate, ethyl (meth)acrylate, propyl (meth)acrylate, isopropyl (meth)acrylate, butyl (meth)acrylate, isobutyl (meth)acrylate, methyl ethacrylate, hexyl (meth)acrylate, n-hexyl (meth)acrylate, heptyl (meth)acrylate, octyl (meth)acrylate, 2-ethylhexyl (meth)acrylate, nonyl (meth)acrylate, decyl (meth)acrylate, isodecyl (meth)acrylate, lauryl (meth)acrylate, myristyl (meth)acrylate, stearyl (meth)acrylate, behenyl (meth)acrylate and melissyl (meth)acrylate.

5. A method of claim 1, wherein said monomer mixture comprises a polyunsaturated crosslinking monomer.

6. A method of claim 1, wherein said monomer mixture comprises at least one polyunsaturated crosslinking monomer selected from allyl pentaerythritol, allyl sucrose, trimethylolpropane diallyl ether, allyl (meth)acrylate, methylenebisacrylamide, and mixtures thereof.

7. A method of claim 1, wherein said monomer mixture comprises: i) from about 95 to about 99.99 wt. % of at least one olefinically unsaturated carboxylic acid group containing monomer, and ii) from about 0.01 to about 5 wt. % of a polyunsaturated crosslinking monomer, based on the total weight of the monomers in the mixture.

8. A method of claim 1, wherein said monomer mixture comprises: i) from about 60 to about 99 wt. % of at least one olefinically unsaturated carboxylic acid group containing monomer, ii) from about 1 to about 40 wt. % of at least one C₁-C₃₀ alkyl ester of (meth)acrylic acid, and iii) from about 0.01 to about 5 wt. % of at least one polyunsaturated crosslinking monomer, based on the total weight of the monomers in the mixture, and wherein the sum of monomer components i)+ii)+iii)=100 wt. % of the total monomers in the mixture.

9. A method of claim 1, wherein said monomer mixture comprises: i) from about 90 to about 96 wt. % (meth)acrylic acid; ii) from about 1 to about 6 wt. % of at least one C₁₀-C₃₀ alkyl ester of (meth)acrylic acid; and iii) from about 0.1 to about 0.5 wt. % at least one polyunsaturated crosslinking monomer based on the total weight of the monomers in the mixture, and wherein the sum of monomer components i)+ii)+iii)=100 wt. % of the total monomers in the mixture.

10. A method of claim 1, wherein said monomer mixture comprises acrylic acid and stearyl methacrylate.

11. A method of claim 1, wherein said deswelling agent is selected from citric acid, acetic acid, alpha-hydroxy acid, beta-hydroxy acid, salicylic acid, lactic acid, glycolic acid, natural fruit acids, hydrochloric acid, nitric acid, sulfuric acid, sulfamic acid, phosphoric acid, and mixtures thereof.

12. A method of claim 1, wherein said deswelling agent is a salt selected from sodium chloride, potassium chloride, lithium chloride, ammonium chloride, salts of fatty acids, and mixtures thereof.

13. A method of claim 1, wherein the amount of the at least one pulverulent partially neutralized carboxylic acid containing homopolymer or copolymer present in the aqueous phase ranges from about 0.1 to about 10 wt. %, or from about 0.3 to about 5 wt. %, or from about 0.5 to about 3 wt. %, or from about 0.75 to 2.5 wt. %, or from about 0.8 to about 2 wt. %, or from about 0.9 to about 1.5 wt. % of active polymer, based upon the total weight of the composition.

14. A method of claim 1, wherein the weight ratio of deswelling agent to the at least one pulverulent crosslinked partially neutralized carboxyl group containing homopolymer or copolymer ranges from about 0.002:1 to about 20:1, or from about 0.1 to about 15:1, or from about 0.3:1 to about 10:1, or from about 0.5:1 to about 5:1, or from about 0.8:1 to about 2:1, or from about 0.9:1 to about 1:1.

15. A method of claim 1, wherein said aqueous medium comprises at least one surfactant selected from an anionic surfactant, a cationic surfactant, a zwitterionic surfactant, and a nonionic surfactant.

16. A method of claim 15, wherein said at least one surfactant is a mixture of an anionic surfactant and an amphoteric surfactant.

17. A method of claim 16, wherein the weight ratio of anionic surfactant to amphoteric surfactant is wherein the ratio of anionic surfactant to amphoteric surfactant (active material) is 10:1 to about 2:1 and 9:1, 8:1, 7:1 6:1, 5:1, 4.5:1, 4:1, or 3:1.

18. A method of claim 1, further comprising:
d) adding a basic material to said aqueous medium to neutralize said partially neutralized carboxylic acid containing polymer or copolymer.

19. A method of claim 17, wherein said basic material is added in an effective amount of yield a composition having a pH ranging from about 5 to about 11, or from about 5.5 to about 9, or from about 6 to about 8, or from about 6.5 to about 7.5.

20. A method of claim 18, wherein said basic material is selected from alkali metal hydroxides (sodium and potassium), organic bases (triethanolamine (TEA), L-arginine, aminomethyl propanol, tromethamine (2-amino 2-hydroxymethyl-1,3-propanediol), PEG-15 cocamine, diisopropanolamine, triisopropanolamine, tetrahydroxypropyl ethylene diamine, and mixtures thereof.

21. The method of claim 1, wherein said polycarboxylic acid containing polymer is present in said aqueous medium in an amount ranging from about 0.1 to about 10 wt. %, or from about 0.5 to about 7 wt. %, or from about 1 to about 5 wt. %, based on the weight of the total composition.
